(19) United States
(12) Patent Application Publication
(10) Pub. No.: US 2005/0142521 A1
(43) Pub. Date: Jun. 30, 2005

(54) Optical language learning machine

(76) Inventor: Hung-Chi Chen, Kaohsiung City (TW)

Correspondence Address: BIRCH STEWART KOLASCH & BIRCH, PO BOX 747, FALLS CHURCH, VA, 22040-0747, US

(21) Appl. No.: 11/017,851

(22) Filed: Dec. 22, 2004

(30) Foreign Application Priority Data
Dec. 24, 2003 (TW) 92222529

(51) Int. Cl. G09B 19/00

(52) U.S. Cl. 434/156

(57) ABSTRACT

An optical learning machine has an optical reader on the bottom end as an input device to read an index code in instructions. The index code is printed in the instructions in a planar manner. A microprocessor located in the machine retrieves an instruction file from a memory card interface in a memory device corresponding to the index code and transforms to sound or images that are sent to audio and image display devices. Hence symbols may be transformed through the optical reader to instruction contents of a multimedia format to be output to achieve an interactive effect.

### FIELD OF THE. INVENTION

The present invention relates to an optical language learning machine and particularly to a language learning machine capable of being teaching instructions and transforming symbols optically to multimedia instruction contents to be output and achieving an interactive effect.

### BACKGROUND OF THE INVENTION

The language learning devices now on the market generally can be classified in language learning machines, translation machines, and pen-type scanners.

The language learning machines generally have A-B section play function. They mostly use magnetic memory devices such as recording tapes, optical recording media such as optical disks, or solid state semiconductor elements such as flash memory to store instruction data. They use pushbuttons as an input device to enable users to play instruction sections.

The translation machines generally use a keyboard to enter a word and translate into another language to be output in a display or audio fashion. Besides converting words, it also provides an instruction function. They generally use a solid state semiconductor such as Read Only Memory (ROM) or memory cards such as Compact Flash Cards to store instruction data.

The pen-type scanner is an improved translation machine that changes the keyboard data entry to a pen-type scanner input. A paragraph of characters may be scanned, recognized and transformed by the scanner to character input to achieve the same effect as keyboard entry.

### SUMMARY OF THE INVENTION

The present invention aims to provide a novel optical language learning machine that includes an optical reader, a microprocessor, a memory device, an audio or image output device and a plurality of pushbuttons and LED indication lights.

The optical reader serves as an input device to read index codes in instructions. The index codes are printed in a planar manner in the instructions, such as a simple format in bar codes, or other means such as color codes. The index codes are read from the instructions and the microprocessor retrieves corresponding instruction files from the memory device that are transformed to audio or image output on the audio and image display devices. The instruction file can store the instruction data in a compressed format, such as the sound is stored in a MP3 sound compressed format. The memory device may be a built-in memory or an expansion card such as the compact flash card. Use of the expansion card makes update of the instructions easier and can avoid the complexity of downloading data into the machine of the invention. The sound is output through the speaker. The invention also provides an earphone output terminal. The image is output through a commonly used display device, such as a LCD. The pushbutton and LED indication light provide a human machine interface for users.

The present invention provides a novel concept of reading the index codes through the optical reading approach to output the interactive instructions from the memory device. The index codes are printed in a planar manner through printers, copies, or the like. Such an approach can reduce cost and improve production flexibility. The optical reader may be a LED transceiver, infrared (IrDA) transceiver, contact image sensor (CIS), color sensor, or the like.

The foregoing, as well as additional objects, features, and advantages of the invention will be more readily apparent from the following detailed description, which proceeds with reference to the accompanying drawings.

### BRIEF DESCRIPTION OF THE DRAWINGS

FIG. 1 is a perspective view of the present invention.

FIG. 2 is a schematic view of the present invention in use.

FIG. 3 is a circuit block diagram of the present invention.

FIG. 4 is a program operation flow chart for machine start and stop of the invention.

FIG. 5 is a program operation flow chart of the invention.

FIG. 6 is a schematic view of the memory card file structure of the invention.

### DETAILED DESCRIPTION OF THE PREFERRED EMBODIMENTS

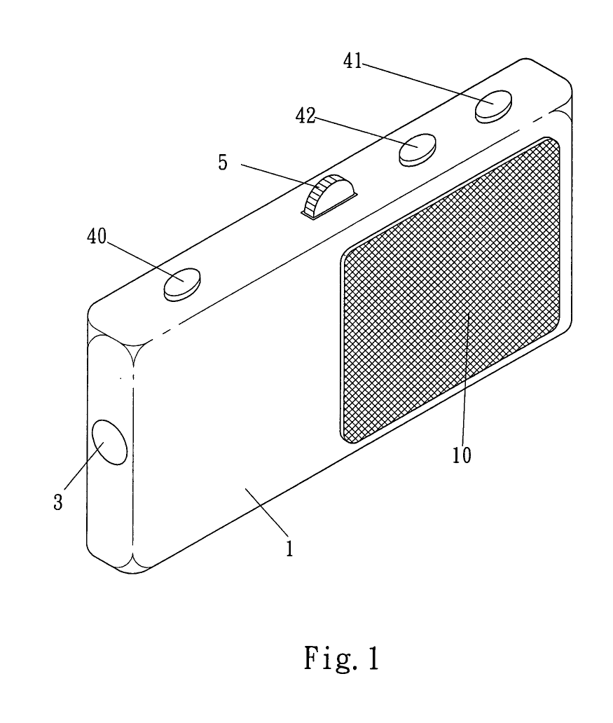

Please refer to FIGS. 1 through 6 for an embodiment of the present invention. The invention includes a box 1 which has a speaker 10 on the front end, an earphone output terminal 2 on one end adjacent to the right side of the front end, an optical reader 3 in the center of the bottom end (including an optical emitter 30 and an optical receiver 31), a pushbutton set 4 on the left side (including a power supply switch 40, a reading button 41, a replay/total play button 42), a sound volume adjustment knob 5, a LED indication light 6 on the top end of the box 1 (including a power supply indication light 60 and a ready indication light 61), an expansion memory card interface 7 extended from the top end of the box 1, and a battery dock 8 located on the rear end of the box 1.

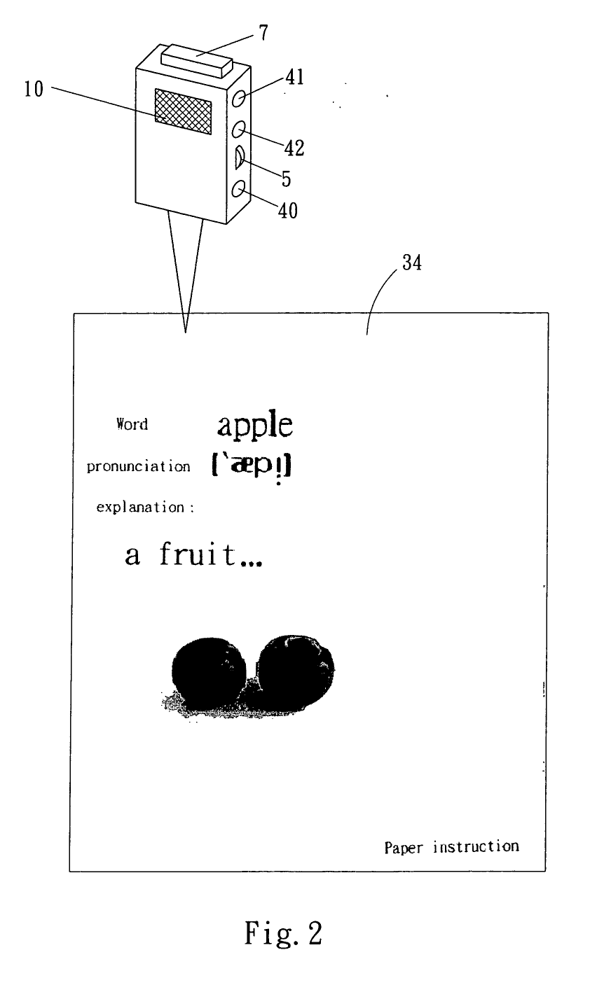

Refer to FIG. 2 for the invention in a use condition. A user can read the bar code in the instructions through an index code 34 of the invention, and transform the bar code to audio output. By this approach various language instructions may be produced.

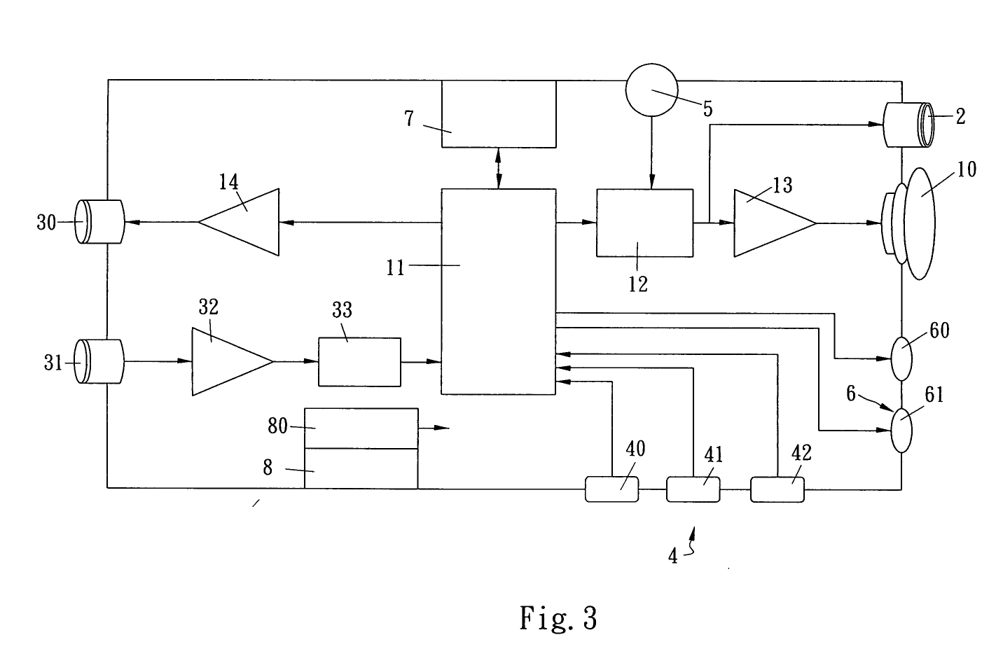

Refer to FIG. 3 for the circuit board block diagram of the invention. It includes a microprocessor 11, a memory card interface 7, an actuation circuit 14, an amplification circuit 32, a filter circuit 33, an optical emitter 30, an optical receiver 31, an audio signal decoding circuit 12, an audio signal amplification circuit 13, a speaker 10, a sound volume adjustment knob 5, a power supply switch button 40, a reading button 41, a replay/total play button 42, a ready indication light 61, a power supply indication light 60, and a power supply circuit 80 above the battery dock 8. The optical emitter 30 of this embodiment is a red LED with a wavelength of 660 nm. The optical receiver 31 is a phototransistor. The microprocessor 11 is PICI6F877 of Microchip Co. The audio instruction is stored in a compact flash card in the MP3 format. The audio processing circuit uses a hardware-based MP3 decoding IC to transform the audio data stored in the compact flash card to audio signals to be output. The audio signal sent to the speaker 10 is driven by the audio amplification circuit 13 before being output by the speaker 10.

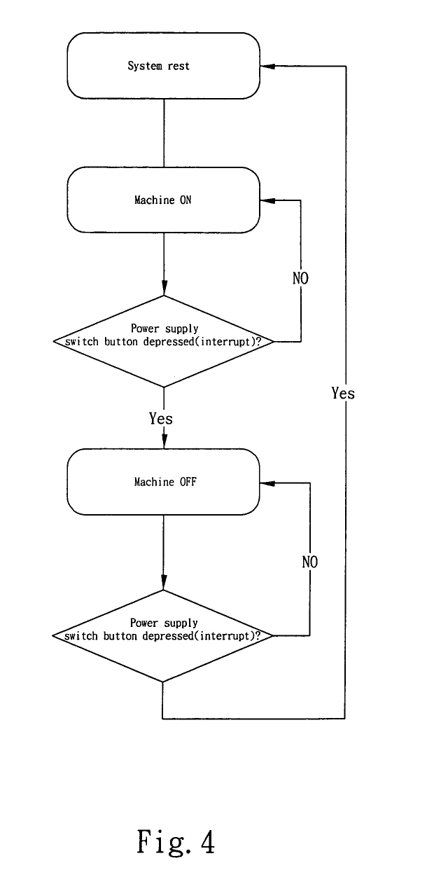

When the embodiment of the invention receives power supply, the microprocessor 11 starts operation and enters a sleep condition to save electricity consumption. Users cannot operate at this moment. When the power supply switch button 40 is depressed, an interrupt signal linking to the microprocessor 11 is generated. The microprocessor 11 wakes up from the sleeping condition, and the power supply indication light 6 is ON to inform the current condition to the user. If the user depresses the power supply switch button 40 while using, the machine returns to the sleeping condition again (also referring to FIGS. 3 and 4).

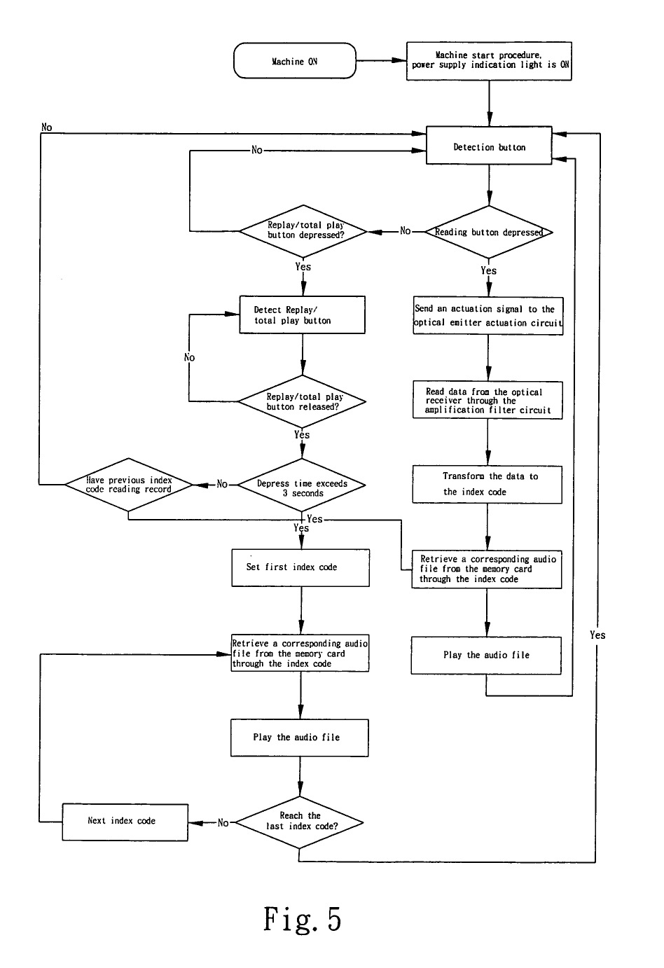

Referring to FIGS. 3 and 5, when the embodiment of the invention is in use, when depressing the reading button 41, the optical reading device 3 can be used to scan the bar codes in the instructions. The signals of bar codes are received by the optical receiver 31 and sent to the microprocessor 11 through the amplification circuit 32 and filter circuit 33. The microprocessor 11 transforms the received signals to the original index code 34. The embodiment uses 39-digit code for the bar code. The microprocessor 11 uses the transformed index code 34 to search the memory of the compact flash card for a file matching the index code 34. The file contains the instruction audio data in a compressed MP3 format. The data is decompressed by the audio decoding circuit 12 to become audio signals and outputs to the earphone output terminal 2 or through the audio signal amplification circuit 13 to actuate the speaker 10 to be output.

If the user has already read the bar code and played the sound, he/she can press the replay/total play button 42 to replay the instruction one more time.

If the user presse the replay/total play button 42 over three seconds, all the contents in the instructions are played sequentially.

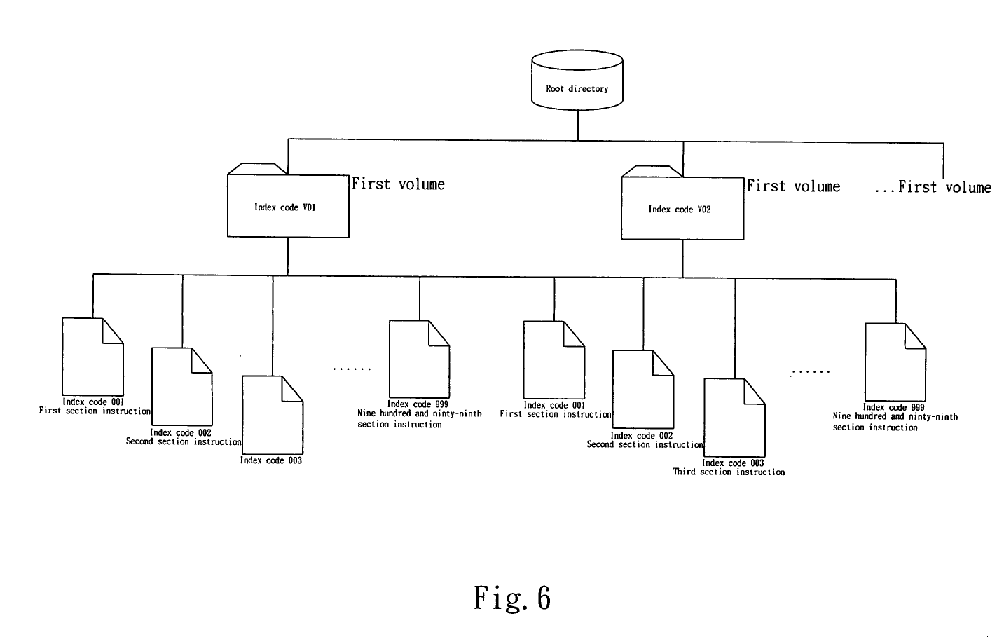

Refer to FIG. 6 for the file structure of the compact flash card. The index code 34 is directly used as the file name. In this embodiment, a sub-directory of the instructions is also provided. Such an approach allows one compact flash card to contain more than one instruction and can increase use convenience. When it is successful to read the bar code, the ready indication light 61 is ON. If the reading fails, the ready indication light 61 is blinking.

1. An optical language learning machine, comprising:
a box having a speaker on a front end, an earphone output terminal on a right end adjacent to the front end, an optical reader in the center of the bottom end, a pushbutton on a left side, a LED indication light on the top end, an expansion memory card interface of a memory device extending from the top end, and a battery dock on a rear end;
a circuit board located in the box having a microprocessor, an audio signal decoding circuit extending from two sides of the microprocessor, an audio signal amplification circuit and a LED indication light on a lower end thereof, an actuation circuit and the optical reader; and
a pushbutton set including a power supply switch button, a reading button, an sound volume adjustment knob, and a replay/total play button that are located on one side of the circuit board;
wherein the optical reader serves as an input device to read an index code in instructions, the microprocessor retrieving an instruction file from the expansion memory card interface of the memory device corresponding to the index code and transforming to sound or images output to an audio and image displaying device.

2. The optical language learning machine of claim 1, wherein the optical reader is selected from a LED transceiver, an infrared (IrDA) transceiver, a contact image censor, and a color sensor.

3. The optical language learning machine of claim 1, wherein
the index code is printed in a planar manner in the instructions.

4. The optical language learning machine of claim 1, wherein the memory device is selected from a built-in memory and an expansion card.

5. The optical language learning machine of claim 1, wherein the LED indication light includes a power supply indication light and a ready indication light.
